(19) United States
(12) Patent Application Publication
(10) Pub. No.: US 2021/0247707 A1
(43) Pub. Date: Aug. 12, 2021

(54) DISCHARGING IMAGE FORMATION TRANSFER MEMBERS

(71) Applicant: Hewlett-Packard Development Company, L.P., Spring, TX (US)

(72) Inventors: Rajesh Kelekar, Palo Alto, CA (US); Napoleon J. Leoni, Palo Alto, CA (US); Omer Gila, Palo Alto, CA (US)

(73) Assignee: Hewlett-Packard Development Company, L.P., Spring, TX (US)

(21) Appl. No.: 17/056,176

(22) PCT Filed: Oct. 29, 2018
(86) PCT No.: PCT/US2018/057993

§ 371 Date: Nov. 17, 2020

(51) Int. Cl. G03G 15/16

(52) U.S. Cl. CPC G03G 15/1635

(57) ABSTRACT

A device includes an at least partially electrically conductive transfer member to travel along a travel path and a first portion along the travel path to receive an image-receiving holder onto the transfer member. A second portion is downstream from the first portion along the travel path to receive ink particles onto the image-receiving holder to form an image, while a transfer station is to transfer the ink particles and the image-receiving holder together from the transfer member to an image formation medium. A discharge element, which is interposed between the transfer station and the first portion, is to cause discharge of the transfer member.

### BACKGROUND

Modern printing techniques involve a wide variety of media, whether rigid or flexible, and for a wide range of purposes.

### BRIEF DESCRIPTION OF THE DRAWINGS

FIG. 1A is a diagram including a side view schematically representing an example image formation device and/or example method.

FIG. 1B is a side view schematically representing a portion of an example image formation medium assembly.

FIG. 1C is block diagram schematically representing an example control portion.

FIG. 1D is a diagram including a side view schematically representing an example image formation device and/or example method.

FIG. 2A is a side view schematically representing an example developer unit of an example image formation device.

FIG. 2B is an enlarged side view schematically representing a portion of an example developer unit and example transfer member of an example image formation device.

FIG. 2C is an enlarged side view schematically representing a portion of an example developer unit and example transfer member in a partially discharged state.

FIG. 3 is a side view schematically representing an example fluid ejection device of an example image formation device.

FIG. 4 is a side view schematically representing an example liquid removal device of an example image formation device.

FIG. 5 is a side view schematically representing an example energy transfer mechanism of an example image formation device.

FIGS. 6A-6B are each a side view schematically representing an example charge source of an example discharge element of an image formation device.

FIG. 6C is a side view schematically representing an example energy source of an example discharge element of an image formation device.

FIG. 7A is a diagram including a side view schematically representing an example image formation device including a transfer drum and/or example method.

FIG. 7B is a diagram including a partial side view schematically representing removable insertion of a fluid ejection device into a receiving portion of an example image formation device.

FIG. 7C is a diagram including a partial side view schematically representing removable insertion of a developer unit into a receiving portion of an example image formation device.

FIG. 8 is a diagram including a side view schematically representing an example image formation device including an endless transfer belt and/or example method.

FIG. 9 is a diagram including a side view schematically representing multiple stations for multi-color printing in an example image formation device.

FIGS. 10A and 10B are a block diagram schematically representing an example control portion and an example user interface, respectively.

FIG. 11 is a flow diagram schematically representing an example method of image formation.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

At least some examples of the present disclosure are directed to a discharging a transfer member of an image formation device. In some examples, the discharge may be implemented after transfer of ink particles and an image-receiving holder from the transfer member to an image formation medium, and/or the discharge may be implemented prior to an initial deposit of an image-receiving holder onto a transfer member.

In some examples, an image formation device comprises a transfer member to travel along a travel path. The device may comprise a first portion along the travel path to receive an image-receiving holder onto the transfer member and may comprise a second portion downstream from the first portion along the travel path to receive ink particles onto the image-receiving holder to form an image. The device also may comprise a transfer station to transfer the ink particles and the image-receiving holder together from the transfer member to an image formation medium.

The device also may comprise a discharge element, interposed between the transfer station and the first portion, to cause discharge of the transfer member. In some such examples, such discharge comprises a discharge of residual positive or negative charges from at least a surface of the transfer member. In some examples, the discharge element may be viewed as operating prior to the first portion and/or as operating after the transfer station.

In some examples, the transfer member may be at least partially electrically conductive and/or the image-receiving holder may comprise an electrically charged, semi-liquid image-receiving holder. In some examples, the second portion is to receive the ink particles as droplets of ink particles within a carrier fluid.

In some examples, the image formation device also may comprise a charge source to emit charges to charge the ink particles to move through the carrier fluid to become electrostatically fixed relative to the image-receiving holder. In some examples, the charge source is located downstream along the travel path T from the second portion (which is to receive ink particles).

In some examples, the image formation device may comprise a liquid removal element downstream from at least the second portion (to receive ink particles) to remove excess liquid from the surface of the image-receiving holder and/or downstream from the charge source (to direct charges onto the ink particles within the carrier fluid).

With this in mind, in some examples the discharge element is positioned and arranged to cause discharge the transfer member, which may restore the transfer member to an electrically neutral state or nearly electrically neutral state. This restoration may prepare the transfer member to receive electrostatic transfer of an image-receiving holder, which may be electrically charged in some examples.

In the absence of such discharge via the discharge element of the examples of the present disclosure, residual charges from prior cycles of image formation may remain on or within the transfer member and result in a voltage build-up on the transfer member. Such voltage build-up may interfere with a complete and/or uniform releasable adherence of the image-receiving holder (from a developer unit) onto or relative to the transfer member. A non-uniform image-receiving holder may, in turn, result in irregular adherence (e.g. electrostatic pinning) of ink particles received into a desired pattern onto the image-receiving holder. An irregular reception of the ink particles, and the presence of a non-uniform underlying image-receiving holder, may facilitate incomplete transfer of an intended image (formed of the ink particles) from the transfer member onto the image formation medium. Taken together, these characteristics may result poor image formation on an image formation medium.

In sharp contrast, at least some example arrangements of the present disclosure, which include use of an example discharge element, may facilitate a complete releasable deposit of the image-receiving holder onto a transfer member, which in turn may facilitate complete reception of deposited ink particles on the image-receiving holder. Via such example arrangements, an image formation device may achieve complete transfer of the image-receiving holder, and the deposited ink particles, from the transfer member to an image formation medium.

In some examples, the image formation device is arranged such that the transfer member travels in a loop, and the discharge element is to cause discharge of the transfer member after the transfer member passes by or through the transfer station (to transfer image to an image formation medium) but prior to subsequent passage of the transfer member by the first portion in which a new image-receiving holder is deposited onto the transfer member.

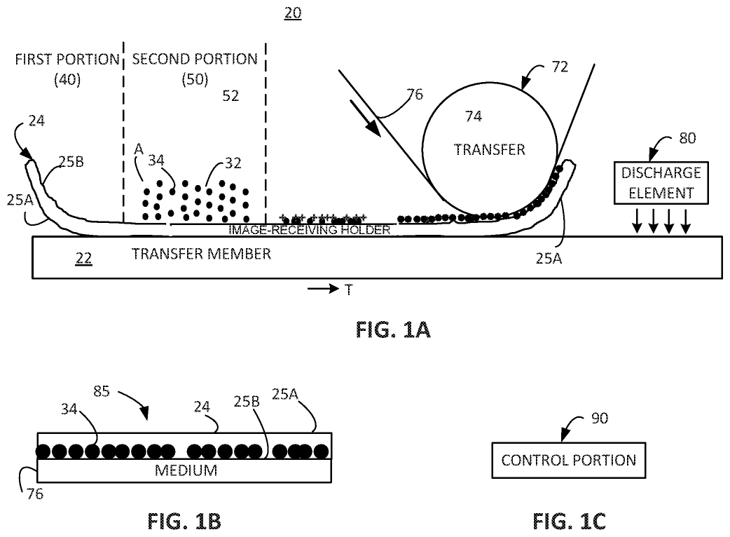

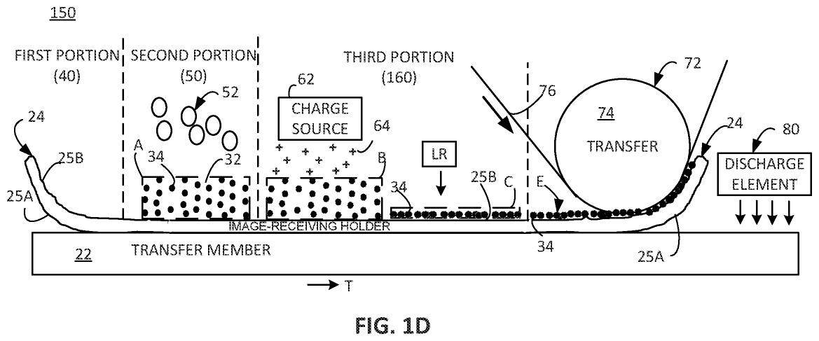

These examples, and additional examples, will be further described below in association with at least FIGS. 1A-11.

FIG. 1A is a diagram including a side view schematically representing an example image formation device 20. It will be further understood that FIG. 1A also may be viewed as schematically representing at least some aspects of an example method of image formation. In some examples, the image formation device may sometimes be referred to as a printer or printing device, image formation press, web press, or digital press.

As shown in FIG. 1A, in some examples the image formation device 20 comprises transfer member 22, first portion 40, second portion 50, transfer station 72, and discharge element 80, each of which will be described below in further detail. Operation of the image formation device 20 results in an image formation medium assembly 85 (e.g. print medium assembly) as shown in FIG. 1B and which may comprise an image-receiving holder 24 covering and bonding an image formed via ink particles 34 on an image formation medium 76 (i.e. print medium). As apparent from FIG. 1B, in at least some examples of image formation medium assembly 85, at least some portions of the image-receiving holder 24 may be in contact with the image formation medium 76.

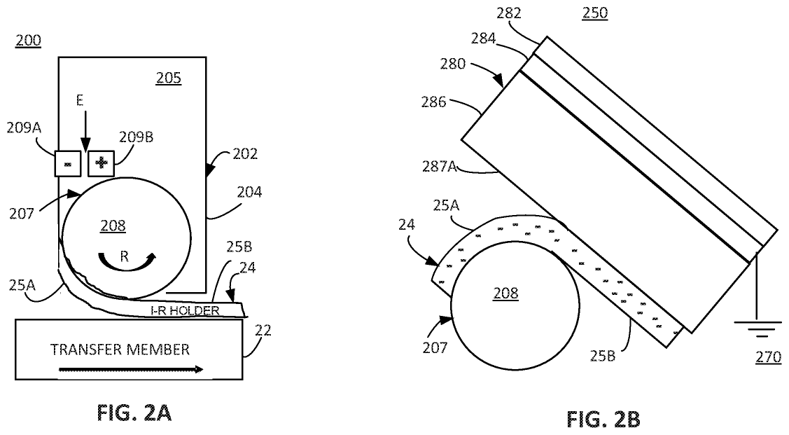

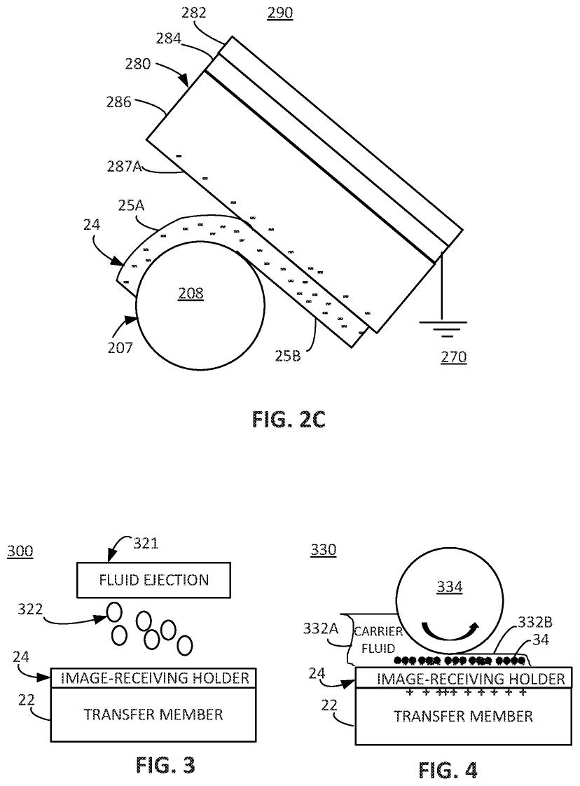

As shown in FIG. 1A, the transfer member 22 moves along a travel path T. In some examples, the transfer member 22 comprises an electrically conductive member, among other layers. In some examples, the transfer member may be referred to as a blanket. In some examples, the electrically conductive portion of the transfer member 22 may be in contact with an electrically conductive ground element such as a brush, roller or plate in rolling or slidable contact, respectively, with a portion of the transfer member 22. In some examples, the ground element is in contact with an edge or end of the transfer member 22. At least one example implementation of the transfer member 22, and an associated ground element, is described later in association with at least FIG. 2B.

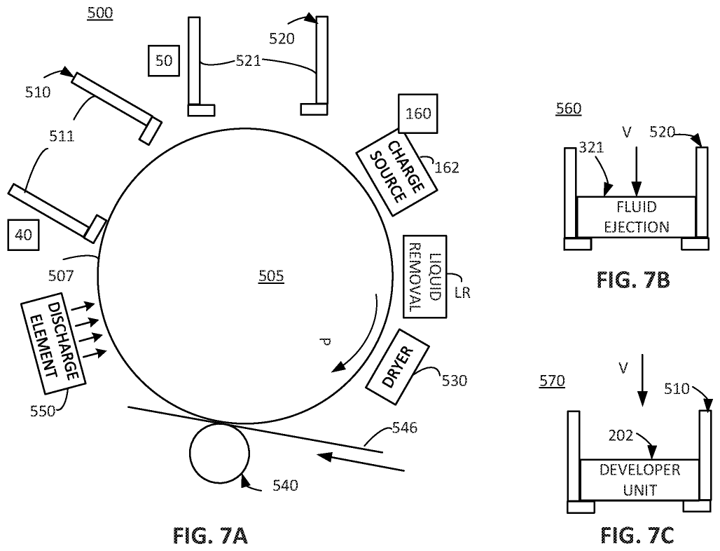

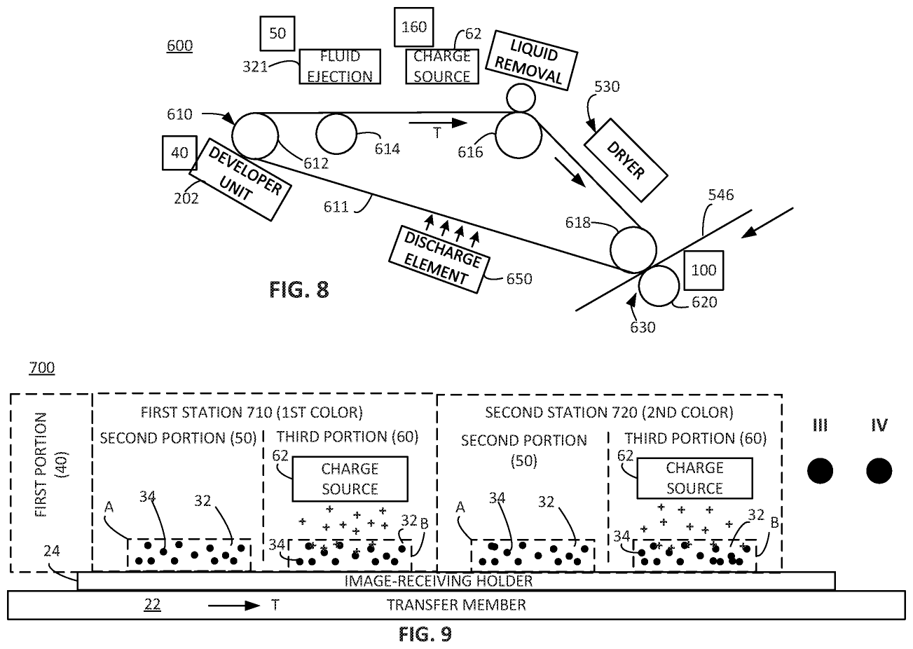

In some examples, transfer member 22 may implemented on, or as part of, an endless belt or web (e.g. 611 in FIG. 8) while in some examples transfer member 22 may be implemented on, or as part of, a rotating drum (e.g. 505 in FIG. 7A). When implemented as an endless belt or web, it will be understood that the transfer member 22 may be moved along travel path T via support from an array of rollers (e.g. 610 in FIG. 8), tensioners, and related mechanisms to maintain tension and provide direction to transfer member 22 along travel path T.

As further shown in FIG. 1A, in some examples the first portion 40 of image formation device 20 is to receive a coating of material on the transfer member 22 to form an image-receiving holder 24. In some such examples, the material comprises a semi-liquid material and may be electrically charged, as further described below. During such coating, the image-receiving holder 24 becomes releasably, electrostatically fixed as a layer relative to the transfer member 22. In this arrangement, a first surface 25A (i.e. side) of the image-receiving holder 24 faces the transfer member 22 while an opposite second surface 25B of the image-receiving holder 24 faces away from transfer member 22.

In some examples, the first portion 40 of image formation device 20 comprises a developer unit to produce and apply the above-described coating of electrically charged, semi-liquid image-receiving holder 24 onto transfer member 22. FIG. 2A provides a diagram 200 schematically representing one example developer unit 202. In some examples, the developer unit 202 may comprise at least some of substantially the same features and attributes as a developer unit as would be implemented in a liquid electrophotographic (LEP) printer, such as but not limited to, an Indigo brand liquid electrophotographic printer sold by HP, Inc. In some examples, the developer unit 202 may comprise at least some of the features of a binary developer (BID) unit as described in Nelson et al. US20180231922.

As shown in FIG. 2A, in some examples, the developer unit 202 comprises a container 204 for holding various materials 205 (e.g. liquids and/or solids) which are developed into the layer 24 forming the image-receiving holder. In some examples, the materials 205 may comprise binding materials, such as resins, binding polymers (dissolved or as particles), as well as materials such as (but not limited to) dispersants, charge directors, mineral oils, foam depressing agents, UV absorbers, cross linking initiators and components, heavy oils, blanket release promoters, and/or scratch resistance additives. In one aspect, the materials 205 in any given formulation of the image-receiving holder 24 are combined in a manner such that materials 205 will be flowable in order to enable formation of image-receiving holder 24 as a layer on transfer member 22. In some examples, a mineral oil portion of the materials 205 is more than 50% by weight of all the materials 205. In some such examples, the mineral oil portion may comprise an isoparrafinic fluid, which may be sold under the trade name ISOPAR.

In some examples, the container 204 of developer unit 202 may comprise individual reservoirs, valves, inlets, outlets, etc. for separating holding at least some of the materials 205 and then mixing them into a desired paste material to form image-receiving holder 24 as a layer on transfer member 22. In some examples, the developed paste which forms image-receiving holder 24 may comprise at least about 20 percent to about 30 percent solids, which may comprise resin and/or other binder components and may comprise at least charge director additives along with the binder materials. In some such examples, the solids and charge director additives are provided within a dielectric carrier fluid, such as but not limited to, a non-aqueous fluid. In some examples, the non-aqueous liquid may comprise an isoparafinic fluid, which may be sold under the trade name ISOPAR. As noted above, in some such examples the carrier fluid comprises more than 50% by weight of all of the materials 205 from which the paste is developed. In some examples, solid particles within the paste have a largest dimension (e.g. length, diameter) on the order of about 1 or about 2 microns.

As further shown in FIG. 2A, the developer unit 202 comprises a roller assembly 207 disposed at least partially within container 204 and selectively exposed to the paste of materials 205 being developed. The roller assembly 207 comprises a developer drum 208, which is driven to a negative voltage (e.g. −500 V) for electrostatically charging the paste of materials 205 and electrostatically delivering the charged paste of materials 205 as layer 24 on the transfer member 22, as shown in FIG. 2B. In one such example, the paste of materials 205 is negatively charged. In some examples, the charge director additives receive and hold the negative charge in a manner to thereby negatively charge at least the binder materials within the paste of materials 205 when an electrical field is applied to the paste of materials 205, such as via the development roller 208 at −500 Volts. Via such example arrangements, the image-receiving holder 24 may sometimes be referred to as an electrically charged, image-receiving holder.

In some examples, the developer drum or roller 208 may comprise a conductive polymer, such as but not limited to polyurethane or may comprise a metal material, such as but not limited to, Aluminum or stainless steel.

In some examples, the materials 205 may start out within the container 204 (among various reservoirs, supplies) with about 3 percent solids among various liquids, and via a combination of electrodes (e.g. at least 209A, 209B in FIG. 2A) “squeeze” the formulation into a paste of at least about 20 percent solids, as noted above. As shown in at least FIG. 2B, the paste of materials 205 is applied as a layer (onto transfer member 22) having a thickness of about 4 to about 8 microns, in at least some examples. It will be understood that the volume and/or thickness of the layer (forming image-receiving holder 24) that is transferred from the developer unit 202 to the transfer member 22 may be controlled based on a voltage (e.g. −500V) of the developer roller 208 and/or a charge level of the solid particles within the paste produced by the developer unit 202.

Accordingly, via such example arrangements, upon rotation of at least drum 208 of the roller assembly 207, and other manipulations associated with container 205, the drum 208 electrostatically attracts some of the charged developed material 205 to form the layer forming image-receiving holder 24, which is then deposited onto transfer member 22 as shown in FIG. 2A according to the voltage difference between the developer roller unit (noted above) and the grounded transfer member 22.

In some examples the transfer member 22 may comprise a transfer member 280. In some such examples, the transfer member 280 comprises an outer layer 286, an electrically conductive layer 284, and a backing layer 282. The transfer member 280 comprises at least some electrically conductive material (e.g. layer 284) which may facilitate attracting the negatively charged paste of materials 205 to complete formation of the image-receiving holder 24 as a layer on a surface 287A of an outer layer 286 of the transfer member 280, as shown in FIG. 2B.

In some such examples, the outer layer 286 of transfer member 280 may comprise a layer which is compliant at least with respect to a particular media onto which the formed image will be transferred. In some examples, the outer layer 286 may comprise a silicone rubber layer and is made of a flexible, resilient material. In some such examples, the electrical conductivity of outer layer 286 may be in the range of about 10⁴ Ohm-cm to about 10⁷ Ohm-cm, although in some examples, the electrical conductivity may extend outside this range. The electrical properties of layer 286 can be optimized with regards to voltage drop, charge conductivity across the layer, response time, and arcing risks.

In some examples, the electrically conductive layer 284 of transfer member 280 may comprise of a conductive rubber like silicone, a conductive plastic like polyvinyl chloride (PVC), or a polycarbonate which typically is doped with carbon pigments to become conductive. In some examples, the electrically conductive layer 284 may comprise other conductive inks, adhesives, or curable conductive paste could also be used as well as metalized layer. In some examples, the electrically conductive layer 284 may comprise a sheet resistance of less than 100 ohm/sq and be made from materials which are more conductive than 0.1 Ohm-cm.

As shown in FIG. 2B, in some examples the electrically conductive layer 284 is electrically connected to an electrical ground 270.

In some examples, the transfer member 280 also comprises a backing layer 282, which in some examples may comprise a fabric, polyamide material, and the like in order to provide some stiffness to the transfer member 280, among other functions. In some examples, the compliant layer 286 may comprise a thickness of about 100 microns while the electrically conductive layer 284 may comprise a thickness on the order of a few microns.

In some examples, the transfer member 280 may comprise a release layer of a few microns thickness on top of the outer layer 286 in order to facilitate release of the image-receiving holder 24 (with an image formed via ink particles thereon) from the transfer member 280 at a later point in time, such as at a transfer station (e.g. 72 in FIG. 1A).

In some examples, the developer unit 202 may comprise a permanent component of image formation device 20, with the developer unit 202 being sold, shipped, and/or supplied, etc. as part of image formation device 20. It will be understood that such “permanent” components may be removed for repair, upgrade, etc. as appropriate.

As further described later in association with at least FIGS. 7A, 7C, in some examples the first portion 40 of image formation device 20 (FIG. 1A) may comprise a first receiving portion 510 to removably receive a developer unit (e.g. 202 in FIG. 2A), such as in some examples in which the developer unit 202 is removably insertable into a first receiving portion 510, as shown in at least FIGS. 7A, 7C. The first receiving portion 510 is sized, shaped, and positioned relative to transfer member (e.g. 505 in FIGS. 7A, 7C), as well as relative to other components of image formation device 20, such that upon removable insertion into to first receiving portion 510 (as represented by arrow V in FIG. 7C), the developer unit 202 is positioned to deliver the image-receiving holder 24 onto transfer member 505, in a manner similar to that shown in FIG. 1A, 2A-2B. In some such examples, the developer unit 202 may comprise a consumable which is periodically replaceable due to wear, exhaustion of a supply of ink-binder material, developer components, etc. In some such examples, the developer unit 202 may be sold, supplied, shipped, etc. separately from the rest of image formation device 20 (or 500 in FIG. 7A, 600 in FIG. 8) and then installed into the respective image formation device (e.g. 20, 150, 500, 600) upon preparation for use of the image formation device at a particular location. The first receiving portion 510 in FIGS. 7A, 7C may sometimes be referred to as a first receptor. Accordingly, it will be apparent that in some examples the first receiving portion 510 may comprise part of the first portion 40 of image formation device 20 in FIG. 1A or part of first portion 40 in image formation device 600 in FIG. 8.

In some examples the first portion 40 of the example image formation device 20 involves developing the image-receiving holder 24 without any color pigments in the image-receiving holder 24, such that the image-receiving holder 24 may sometimes be referred to as being colorless. In this arrangement, in some examples the image-receiving holder 24 corresponds to a liquid-based ink formulation which comprises at least substantially the same components as used in liquid electrophotographic (LEP) process, except for omitting the color pigments. In addition to being colorless in some examples, the ink-binder material also may be transparent and/or translucent upon application to an image formation medium or to a transfer member 22.

In some examples, the image-receiving holder 24 may comprise some color pigments so as to provide a tint. In some such examples, such color pigments may be transparent or translucent as well so as to not interfere with, or otherwise, affect the formation or appearance of an image via the ink particles 34 deposited in second portion 50, such as via a fluid ejection device (e.g. 321 in FIG. 3).

In at least some examples in which the image-receiving holder 24 omits color pigments, the materials of the image-receiving holder 24 effectively do not comprise part of the image resulting from the deposited color ink particles which will be later transferred (with the image-receiving holder 24) onto an image formation medium. Accordingly, in some such examples the image-receiving holder 24 also may sometimes be referred to as a non-imaging, image-receiving holder 24.

In some such examples, the image-receiving holder 24 comprises all (e.g. 100 percent) of the binder used to hold an image (formed of and including ink particles 34) on transfer member 22 and later on an image formation print medium. In some such examples, image-receiving holder 24 comprises at least substantially all (e.g. substantially the entire volume) of the binder used to hold the image (including ink particles). In some such examples, in this context the term “at least substantially all” (or at least substantially the entire) comprises at least 95%. In some such examples “at least substantially all” (or at least substantially the entire) comprises at least 98%. In some examples in which the image-receiving holder 24 may comprise less than 100 percent of the binder used to hold the image on the transfer member 22 (and later on an image formation medium), with the remaining desired amount of binder being provided from droplets (e.g. 52 in FIG. 1D, 322 in FIG. 3) delivered in the first portion 40 of image formation device 20. It will be understood that the term binder may encompass resin, binder materials, and/or polymers, and the like to complete image formation with the ink particles 34.

As further noted below, formulating the image-receiving holder 24 to comprise at least substantially all of the binder material(s) to be used to hold the image relative to the transfer member 22 (and later on an image formation medium) acts to free the second portion 50 (and fluid ejection device 321) so that, in at least some examples, the droplets (e.g. 52 in FIG. 1D, 322 in FIG. 3) may omit any binder material, and therefore be “binder-free.” Accordingly, in some examples, the droplets 52 may sometimes be referred to as being binder-free droplets.

In some examples, such droplets may omit charge director additives and therefore such droplets may sometimes be referred to as being charge-director-free. In some such examples, the image-receiving holder 24 may comprise some charge-director additives as further described with respect to developer unit 202 (FIG. 2A-2B).

This example arrangement of supplying all or substantially all of the binder (for forming the image) via the image-receiving holder 24 may help to operate a fluid ejection device (e.g. 321 in FIG. 3, 6-7) with fewer maintenance issues because the absence (or nearly complete absence) of a binder in the droplets may avoid fouling the ejection elements, which may sometimes occur with droplets including binder material for forming an image on an image formation medium. In addition to simplifying maintenance, this arrangement may increase a longevity of the ejection elements (e.g. printhead) of the fluid ejection device (e.g. 321 in FIG. 3).

In some examples, the developer unit 202 is to apply the image-receiving holder 24 in a volume to cover at least substantially the entire surface of the transfer member 22 in at least the area in which the image is be formed on transfer member 22 and immediately surrounding regions. In some examples, in this context, the term “substantially the entire” comprises at least 95 percent, while in some examples, the term “substantially the entire” comprises at least 99 percent.

In some examples, the image-receiving holder 24 is applied to form a uniform layer covering an entire surface of the transfer member 22 (at least including the area in which an image is to be formed). This arrangement stands in sharp contrast to some liquid electrophotographic printers in which liquid ink (with color pigments) is applied just to areas of a charged photo imaging plate (PIP), which have been discharged in a pattern according to the image to be formed. According, the application of a uniform layer (covering an entire surface of the transfer member 22) of the image-receiving holder in the example image formation device 20 bears no particular relationship to the pattern of an image to be formed on the image-receiving holder 24. Therefore, in some instances, the image-receiving holder 24 may sometimes be referred to as a non-imaging, image-receiving holder 24.

As further described later, the application and releasable adherence of the image-receiving holder 24 as a uniform layer may be facilitated via the example discharge element 80 shown in FIG. 1A acting to neutralize any residual charges built up on the transfer member 22 form prior cycles of image formation. The example discharge element 80 will be further described below.

In another aspect, coating image-receiving holder 24 on transfer member 22 may effectively eliminate “image memory” which otherwise may sometimes occur when forming ink images directly on a transfer member 22. In addition, the coating of image-receiving holder 24 on the transfer member 22 may protect the transfer member 22 from dust from a print medium (e.g. paper dust) and/or from plasma associated with production of charges, such as charges 64 produced via a charge source 62, as described later in association with at least FIG. 1D. Among other aspects, this arrangement may increase a longevity of the transfer member 22. In some examples, the employment of the image-receiving holder 24 to receive and transfer an image (made of ink particles 34) may substantially increase the longevity of the transfer member 22. In some examples, in this context the term “substantially increase” may correspond to an increase in longevity of at least 25%, at least 50%, or at least 75%. In some examples, in this context the term “substantially increase” may correspond to an increase in longevity of at least 2×, at least 3×, or at least 5×.

It will be understood that the developer unit 202 (which may be permanent or may be removably insertable into first receiving portion 510) may be implemented in an image formation device whether the transfer member 22 is in the form drum as shown in FIG. 7A or in the form of a belt as shown in FIG. 8.

As further shown in FIG. 1A, in some examples the second portion 50 of image formation device 20 is located downstream from the first portion 40 along the travel path T, and is to receive ink particles 34 on the image-receiving holder 24 as carried by transfer member 22.

In some examples, the second portion 50 receives the ink particles 34 in the form of droplets 52 comprising the ink particles 34 within a carrier fluid, as shown in the example image formation device 150 in FIG. 1D or in FIG. 3. In some examples, the carrier fluid comprises a dielectric material and may comprise a non-aqueous liquid. As shown in FIG. 1D, the depiction within the dashed lines A in the second portion 50 represents ink particles 34 and carrier fluid 32 after being received on the image-receiving holder 24 (on transfer member 22) to form at least a portion of an image on the image-receiving holder 24.

In some examples, the droplets 52 from which ink particles 34 are formed may comprise pigments, dispersants, the carrier fluid 32, etc. In some examples, the droplets 52 may comprise at least some binder materials. However, in at least some examples, the droplets 52 omit binder materials (e.g. resin, binding polymers, etc.), which are instead supplied via the image-receiving holder 24.

As previously noted, in some examples the second portion 50 of the image formation device 20 in FIG. 1A may comprise a fluid ejection device. Accordingly, FIG. 3 is a diagram 320 including a side view schematically representing an example fluid ejection device 321 which may be implemented as part of the second portion 50, in some examples. As shown in FIG. 3, fluid ejection device 321 is positionable at a location spaced apart and above the transfer member 22 (and image-receiving holder 24 thereon) to eject droplets 322 of ink particles within a carrier fluid. In some examples, droplets 322 may comprise one example implementation of droplets 52 and/or droplets 322 may comprise at least some of substantially the same features and attributes as droplet 52 in FIG. 1A.

In some examples, the fluid ejection device 321 comprises a drop-on-demand fluid ejection device. In some examples, the drop-on-demand fluid ejection device comprises an inkjet printhead. In some examples, the inkjet printhead comprises a piezoelectric inkjet printhead while in some examples, the inkjet printhead comprises a thermal inkjet printhead. In some examples, the fluid ejection device 321 may comprise other types of inkjet printheads.

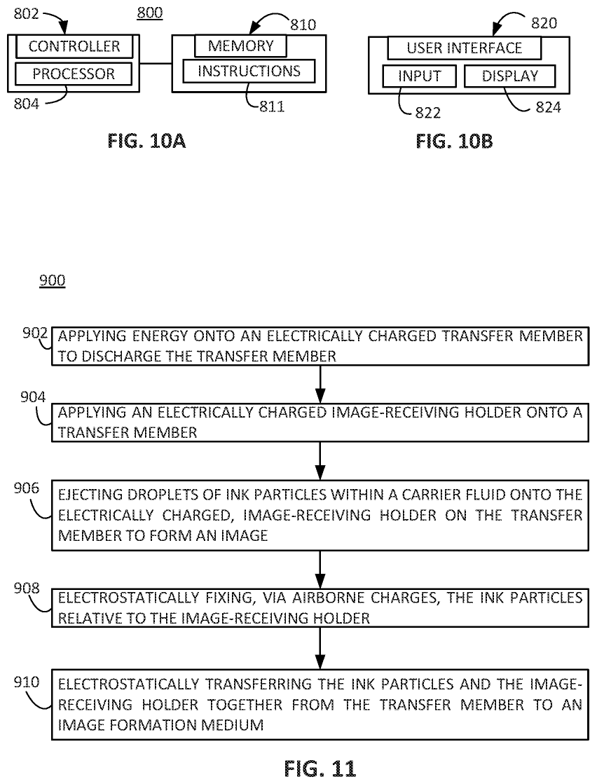

In some examples, as further described later in association with at least FIG. 10A, among directing other and/or additional operations, a control portion 800 is instruct, or to cause, the fluid ejection device 321 to deliver the droplets 322 (e.g. 52 in FIG. 1D) of ink particles 34 within the dielectric carrier fluid 32 onto the image-receiving holder 24 on transfer member 22, such as within the second portion 50 along the travel path T of image-receiving holder 24 (on the transfer member 22).

In some examples, the fluid ejection device 321 may comprise a permanent component of image formation device 20, with the fluid ejection device 321 being sold, shipped, and/or supplied, etc. as part of image formation device 20. It will be understood that such “permanent” components may be removed for repair, upgrade, etc. as appropriate.

As further described later in association with at least FIGS. 7A-7B, in some examples the second portion 50 of image formation device 20 in FIG. 1A may comprise a second receiving portion 520 to removably receive a fluid ejection device (e.g. 321 in FIG. 3), such as in some examples in which the fluid ejection device 321 is removably insertable into the second receiving portion 520, as shown in at least FIGS. 7A-7B. The second receiving portion 520 is sized, shaped, and positioned relative to transfer member (e.g. 505 in FIG. 7A), as well as relative to other components of image formation device 20, such that upon removable insertion relative to second receiving portion 520 (as represented by arrow V in FIG. 7B), the fluid ejection device 321 is positioned to deliver (e.g. eject) the droplets 322 of ink particles 34 and dielectric carrier fluid 32 on the image-receiving holder 24 carried by transfer member 22, in a manner similar to that shown in FIG. 2A.

In some such examples, the fluid ejection device 321 may comprise a consumable which is periodically replaceable due to wear, exhaustion of an ink supply, etc. In some such examples, the fluid ejection device 321 may be sold, supplied, shipped, etc. separately from the rest of image formation device 20 (or 500 in FIG. 7A, 600 in FIG. 8) and then installed into the respective image formation device (e.g. 20, 150, 500, 600, etc.) upon preparation for use of the image formation device at a particular location. The second receiving portion 520 may sometimes be referred to as a second receptor. In some examples, the second receiving portion 520 may comprise supports 521.

It will be understood that the second receiving portion 520 may be implemented in a second portion 50 of an image formation device whether the transfer member 22 is in the form drum as shown in FIG. 7A or in the form of a belt as shown in FIG. 8.

With further reference to at least FIGS. 1A, 1D, 3, 6-8, in some examples, as part of ejecting droplets (e.g. 52, 322), a fluid ejection device is to deposit the dielectric carrier fluid 32 on the image-receiving holder 24 as a non-aqueous liquid. In some examples, the non-aqueous liquid comprises an isoparrafinic fluid, which may be sold under the trade name ISOPAR. In some such examples, the non-aqueous liquid may comprise other oil-based liquids suitable for use as a dielectric carrier fluid.

As further shown in FIG. 1A, in some examples image formation device 20 may further comprise a transfer station 72 downstream from at least the second portion 50. Via at least a transfer roller 74 (e.g. drum) the transfer station 72 is to transfer at least substantially the entire image-receiving holder 24 with at least substantially the entire volume of ink particles 34 thereon (in the form of an image) onto an image formation medium 76 (e.g. image formation medium). As previously noted, this complete (or nearly complete) transfer may increase image quality, protect the transfer member, etc. In addition, in this way, no residue is left remaining on the transfer member, thereby simplifying or eliminating later cleaning of the transfer member, such as between consecutive printing episodes.

In some examples, the transfer station 72 may employ heat, pressure, and/or electrical bias, etc. in order to effect the above-described transfer.

In addition, by transferring the image-receiving holder 24 with the ink particles 24 (as a pattern or form of an image) at transfer station 72, the image-receiving holder 24 becomes an outermost layer of a completed image formation medium assembly 85 shown in FIG. 1B, thereby protecting the image formed of ink particles 34 and helping bond the formed image to the image formation medium 76.

In some examples, the image-receiving holder 24 may sometimes be referred to as an image receiver or an image holder. In some examples, the image-receiving holder 24 may sometimes be referred to as an initial image formation medium (i.e. initial print medium) because the image is formed on, and remains on, the image-receiving holder. Meanwhile, the “medium” (e.g. 76 in FIG. 1A) to which the ink particles and the image-receiving holder are transferred together (via a transfer station) may sometimes be referred to as a second image formation medium (i.e. second print medium) or a final image formation medium (i.e. final print medium). In some examples, the initial image formation medium (e.g. 24 in FIG. 1A) and the final image formation medium (e.g. 76 in FIGS. 1A-1B) may sometimes be referred to as a first image formation medium and a second image formation medium, respectively. In some such examples, the second or final image formation medium is part of an image formation medium assembly (e.g. 85 in FIG. 1B) in which the image made of a pattern(s) of ink particles 34 are at least partially sandwiched between the initial (or first) image formation medium 24 (e.g. image-receiving holder) and the final (or second) image formation medium 76. In some such examples, the image formed of a pattern(s) of ink particles 34 becomes at least partially sandwiched between the first and second image formation mediums with some portions of the respective first and second image formation mediums (e.g. 24, 76) being in direct contact with each other, as shown in FIG. 1B in one example.

In some examples, the second image formation medium may sometimes be referred to as a cover layer or outer layer relative to the ink particles and relative to the first image formation medium (i.e. image-receiving holder).

In some examples, the image-receiving holder may sometimes be referred to as an image-receiving medium. In some examples, the semi-liquid image-receiving holder may sometimes be referred to as a paste, a semi-liquid base, semi-solid base, or base layer.

It will be understood that in some examples, the sequence of operation of some portions of image formation device 20 may be re-arranged in some instances. Moreover, it will be understood that in some examples the labeling of the various portions as first, second, etc. (e.g. 40, 50, etc.) does not necessarily reflect an absolute ordering or position of the respective portions along the travel path T. Moreover, such labeling of different portions also does not necessarily represent the existence of structural barriers or separation elements between adjacent portions of the image formation device 20. Furthermore, in some examples, the components of the image formation device 20 may be organized into a fewer or greater number of portions than represented in FIG. 1A.

Upon completion of the transfer of the image-receiving holder 24 and ink particles 34 from the transfer member 22 (e.g. 280 in FIG. 2B) onto the image formation medium 76, at least some examples of the present disclosure comprise discharge of the transfer member 22 such as via operation of discharge element 80 downstream from the transfer station 72, as shown in FIG. 1A.

In general terms, the discharge element 80 is positioned and arranged to actively cause discharge the transfer member 22 to restore the transfer member 22 to an electrically neutral state, which prepares the transfer member 22 to receive electrostatic transfer of an image-receiving holder 24 in the first portion 40 (e.g. FIGS. 2A-2B, 7A). At least some of these example arrangements also may facilitate complete transfer of the image-receiving holder 24 off the transfer member 22, such as at the transfer station 72. In one aspect, this example implementation may be achieved via avoiding or counteracting a build-up of charges from previous image formation cycles, which may have resulted in a voltage build-up on the image-receiving holder 24 and deterioration of the image formation capability.

Some example implementations of discharge element 80 are shown in FIGS. 6A-6C. However, prior to a more detailed description of example implementations of discharge element 80, additional features and attributes of some example image formation devices will be described in association with at least FIG. 1D. In particular, FIG. 1D schematically represents an example image formation device 150 which comprises at least some of substantially the same features and attributes as the image formation device 20 as previously described, except further comprising additional portions, elements, etc.

For instance, as further shown in FIG. 1D, in some examples image formation device 150 comprises a third portion 60 located downstream along the travel path T from the second portion 50 and includes a charge source 62 to emit airborne charges 64 to charge the ink particles 34, as represented via the depiction in dashed lines B in FIG. 1D. Once charged, the ink particles 34 move, via attraction relative to the charged image-receiving holder 24 (and transfer member 22), through the carrier fluid 32 toward the second surface 25B of the image-receiving holder 24 to become electrostatically fixed on the image-receiving holder 24, as represented via the depiction in dashed lines C in FIG. 1D.

With further reference to FIG. 1D, in some examples the charge source 62 in the third portion 60 may comprise a cold plasma generator, such as a corona, cold plasma element, scorotron, or other charge generating element to generate a flow of charges 64. The generated charges may be negative or positive as desired. In some examples, the charge source 62 may comprise an ion head to produce a flow of ions as the charges. It will be understood that the term “charges” and the term “ions” may be used interchangeably to the extent that the respective “charges” or “ions” embody a negative charge or positive charge (as determined by charge source 62) which can become attached to the ink particles 34 to cause all of the charged ink particles to have a particular polarity, which will be attracted to ground. In some such examples, all or substantially all of the charged ink particles 34 will have a negative charge or alternatively all or substantially all of the charged ink particles 34 will have a positive charge. In one example, the charges 64 are positive charges as shown in FIG. 1D. While the charges 64 shown in the various examples in FIGS. 1A-11 are depicted as having a particular polarity (positive or negative), it will be understood that the polarity of charges 64 may be selected and implemented in view of the polarity of other elements of an example image formation device (or associated with an example image formation device), such as a polarity of elements (e.g. charge directors, binder particles) within the electrically charged, image-receiving holder 24. It will be understood that other elements (e.g. transfer member 22, 280) in contact with image-receiving holder 24 may exhibit, may develop, or be caused to exhibit charges having a polarity opposite from the polarity of the charges 64 (and therefore opposite from the polarity of the charged ink particles 34). Via such example arrangements of opposite polarity charges, the electrostatic attraction forces may be at least partially implemented. In some examples, the charges 64 may affect the charge level and/or the polarity of image-receiving holder 24 to keep the electrostatic attraction forces of particles 34 at least partially implemented.

Via such example arrangements, the charged ink particles 34 become electrostatically fixed on the electrically charged, image-receiving holder 24 in a location on the image-receiving holder 24 generally corresponding to the location (in an x-y orientation) at which they were initially received onto the image-receiving holder 24 in the second portion 50 of the image formation device 20. Via such electrostatic fixation, the ink particles 34 will retain their position on electrically charged, image-receiving holder 24 even when other ink particles (e.g. different colors) are added later with additional liquid, even when excess liquid is mechanically removed, etc. It will be understood that while the ink particles 34 may retain their position on image-receiving holder 24, some amount of expansion of a dot (formed of ink particles 34) may occur after the ink particles 34 (within carrier fluid 32) are jetted onto image-receiving holder 24 and before they are electrostatically pinned in their respective locations (which forms the pattern of the image). In some examples, the charge source 42 is spaced apart by a predetermined distance (e.g. downstream) from the location at which the droplets 52 are received (or ejected) in order to delay the electrostatic fixation (per operation of charge source 62), which can increase a dot size on image-receiving holder 24, which in turn may lower ink consumption.

As shown in FIG. 4, in some examples the image formation device (e.g. 20 in FIG. 1A; 150 in FIG. 1D) may comprise a liquid removal portion LR located downstream along the travel path T from the third portion 160 shown in FIG. 1D. In some examples, the liquid removal element LR may be interposed between the second portion 50 and the third portion 160.

The liquid removal element LR may at least mechanically remove excess volumes of liquid, including carrier fluid 32, which has accumulated on the image-receiving holder 24 as a result of receiving droplets 52 in the second portion 50 of the image formation device 20, 150. After fixation of ink particles 34 (in the form of at least a portion of an image) as shown via the dashed box C in third portion 160 in FIG. 1D, the excess liquid is no longer useful for the current instance of image formation and therefore is removed per liquid removal element LR. In some examples, the collected excess liquid may be recovered and re-used in future depositions of droplets in the second portion 50 in subsequent instances of image formation via the image formation device 150 and/or re-used for other purposes.

In some examples, the liquid removal element(s) LR is to remove the carrier fluid 32 without heating the fluid 32 at all or without heating the carrier fluid 32 above a predetermined threshold. In some instances, such liquid removal may sometimes be referred to as cold liquid removal (e.g. cold oil removal) by which the liquid is removed at relatively cool temperatures, at least as compared to high heat drying techniques. Accordingly, in some such examples, a mechanical element (e.g. squeegee roller) of the liquid removal element(s) LR may slightly heat the carrier fluid 32 and/or other liquid without using heat as a primary mechanism to remove the carrier fluid 32 from the ink particles 34 on image-receiving holder 24. In some such examples, performing such cold liquid removal may substantially decrease the amount of energy used to remove deposited liquid (e.g. from the top of image-receiving holder 24) as compared to using a heated air dryer primarily or solely to remove the liquid. In some examples, in this context the term substantially decrease” may correspond to at least 10×, at least 20×, or at least 30×. In addition, using cold oil removal via example image formation devices may significantly decrease the space or volume occupied by the example image formation device 20, thereby reducing its cost and/or cost of space in which the image formation device 20 may reside.

As further shown in the diagram of FIG. 4, in some examples the liquid removal element(s) LR may comprise a liquid removal element 330, which may comprise a squeegee and/or roller 334 or other mechanical structure to remove the excess carrier fluid 332A (e.g. 32, and any other liquid) from the surface of image-receiving holder 24. In some examples, the ink particles 34 remain fixed in their respective locations (e.g. pattern) on image-receiving holder 24 during this mechanical removal of liquid. In some such examples, the ink particles 34 remain in their respective locations at least because electrostatic fixation forces are exerted on the ink particles 34, as further described later. The electrostatic forces are greater than the shear forces exhibited via the tool(s) used to mechanically remove the carrier fluid 322A. As previously noted, after such liquid removal, in some examples a minimal amount 332B of liquid may remain with ink particles 34 on image-receiving holder 24 as shown in FIG. 4.

Via the liquid removal element LR, 330, in some examples at least 80 percent of the carrier fluid 32, 332A jetted onto the image-receiving holder 24 is removed. In some examples, at least 90 percent of the jetted carrier fluid 32, 322A is removed. In some examples, at least 95 percent of the jetted carrier fluid 32, 322A is removed. However, in some examples, liquid removal element(s) LR, 330 may remove at least 50 percent of total liquid, which includes the carrier fluid 32, from image-receiving holder 24.

In some examples the image formation device 20 may further comprise a second liquid removal portion downstream from the liquid removal element(s) LR shown in FIG. 1D. This second liquid removal portion acts to remove any liquid not removed via the liquid removal element(s) LR and thereby result in dried ink particles 34 on the image-receiving holder 24, as indicated via arrow E in FIG. 1D. In some examples, at least some of the liquid removed via the second liquid removal portion includes some liquid (e.g. carrier fluid) from the image-receiving holder 24 such that operation of the second liquid removal portion facilitates further solidification of the image-receiving holder 24 prior to its transfer to an image formation medium (e.g. 76 in FIG. 1B).

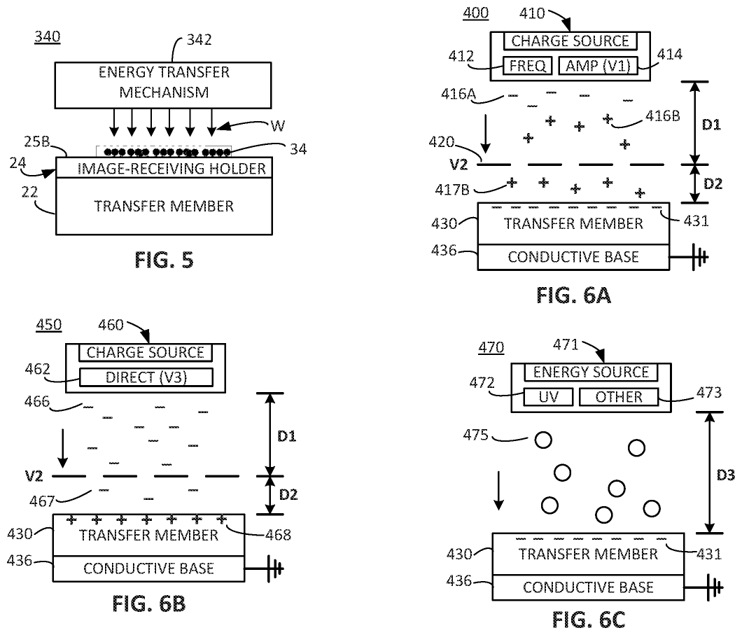

In some such examples, this second liquid removal portion may be implemented as shown in the diagram 340 of FIG. 5 as an energy transfer mechanism 342 by which energy (represented via arrows W) is transferred to the liquid 32, ink particles 34, and image-receiving holder 24 in order to dry the ink particles 34 on the image-receiving holder 24 and/or dry the image-receiving holder 24.

In some examples, the energy transfer mechanism 342 may comprise a heated air element to direct heated air (represented via W) onto at least the carrier fluid 32 and ink particles 34 on image-receiving holder 24. In some examples, the heated air is controlled to maintain the ink particles 34, image-receiving holder 24, etc. at a temperature below 60 degrees C., which may prevent irregularities in the image-receiving holder 24.

In some examples, the energy transfer mechanism 342 may comprise a radiation element to direct at least one of infrared (IR) radiation and ultraviolet (UV) radiation (as represented via arrows W) onto the liquid 32, ink particles 34, and in image-receiving holder 24 to eliminate liquid remaining after operation of the first liquid removal element(s) 82.

While at least some examples of image formation device 150 may comprise an energy transfer mechanism 342 to remove remaining amounts of liquid after liquid removal element(s) LR (FIG. 1D), it will be understood that the transmitted energy also may facilitate solidifying the binder (from image-receiving holder 24) with ink particles 34 to complete formation and solidification of the image on the image-receiving holder 24.

It will be understood that upon completion of the transfer of the image-receiving holder 24 and ink particles 34 from the transfer member 22 onto the image formation medium 76 as shown in FIG. 1D, at least some examples of the present disclosure comprise discharge of the transfer member 22 such as via operation of discharge element 80 downstream from the transfer station 72, as shown in FIG. 1D.

Accordingly, in association with FIGS. 6A-6C, several example implementations of a discharge element 80 are described below and which may implemented as a discharge element 80 in one of the previously described examples of image formation devices 20, 150.

For instance, as shown in the diagram 400 of FIG. 6A, in some examples a discharge element 40 (e.g. 80 in FIG. 1) may comprise a charge source 410 and grid 420 for use in discharging a transfer member 430. The transfer member 430 may comprise at least some of substantially the same features and attributes as transfer member 22 in FIGS. 1A, 1D, 2A and/or 280 in FIG. 2B.

In some examples, the discharge element 400 may comprise at least some of substantially the same features and attributes as, and/or provides an example implementation of, the various example discharge elements 80, 550, 650, etc. described throughout of the present disclosure.

The grid element 420 is spaced apart from the transfer member 430 by a distance D2, while the charge source 410 is spaced apart from the grid element 420 by a distance D1. In some examples, the distances D1 and D2 are each about 0.1 millimeters to about 100 millimeters. In some examples, the distances D1, D2 are each about 0.5 millimeters to about 50 millimeters, while in some examples, the distances D1, D2 are each about 1 to about 20 millimeters. In some examples, the distance D2 can match the distance D1 while in some examples, the distance D2 differs from the distance D1.

In some examples, the charge source 410 may comprise a cold plasma generator, which may comprise a corona, plasma element, or other charge generating element to generate a flow or flux of charges 416A. In some such examples, the charge generating element(s) may comprise a scorotron, array of needle electrodes, and the like.

In some examples, such as when the charge source 410 comprises a corona, the corona may operate at a frequency 412 and an amplitude 414 (e.g. a voltage as represented by V1) to produce an on-going flux of charges 416A. In some examples, the frequency may be a frequency within a range of about 1000 Hertz to about 100,000 Hertz.

The generated charges may be negative or positive as desired. In some examples, the charge source 410 may comprise an ion head to emit or produce a flow of ions as the charges 416A. It will be understood that the term “charges” and the term “ions” may be used interchangeably to the extent that the respective “charges” or “ions” 416A embody a negative charge or positive charge (as determined by source 410) which can move toward a grid element 420 and/or electrically conductive transfer member 430, as further described below.

While the charges 416A shown in FIG. 6A (as well as the various examples throughout the present disclosure) are depicted as having a particular polarity (positive or negative), it will be understood that the polarity of charges (e.g. 416A) may be selected and implemented in view of the polarity of other elements of an example image formation device (or associated with an example image formation device), such as a polarity of elements (e.g. charge directors, binder particles) within an image-receiving holder layer (e.g. 24 in FIGS. 2A-2B, FIGS. 3-5, FIG. 9; 430 in FIGS. 6A-6C; 507 in FIG. 7A; 611 in FIG. 8, etc.). It will be understood that other elements such as at least a portion of the transfer member 22 (also e.g. 280 in at least FIG. 2B) in contact with (or otherwise coupled to) may exhibit, may develop, or be caused to exhibit charges having a polarity opposite from the polarity of the charges 416A (and therefore opposite from the polarity of the charged ink particles 34). Via such example arrangements of opposite polarity charges, the discharge of a transfer member in at least some examples may be at least partially implemented.

As further shown in FIG. 6A, in some examples the grid element 420 is interposed between the charge source 410 and the transfer member 430. In at least some examples, the grid element 420 may act as a control mechanism, in cooperation with operation of the charge source 410 and/or control portion 800 (FIG. 10A), to regulate an amount and polarity of charge on the transfer member 430. Via the assistance of the grid element 420, the charge source 410 may cause a controllable discharge of residual charges on the transfer member 430.

In some examples, the grid element 420 is operated at a voltage between about −100 Volts to about 100 Volts (relative to ground), and may comprise an array of conductive holes through which the charges 416A, 416B may pass to travel into engagement with transfer member 430, as will be further described below. In some examples, the array of conductive holes do not comprise an array of individually addressable nozzles. In some examples, the operating voltage (V1) of the grid element 420 may comprise about −1000 Volts to about 1000 Volts, while in some examples, the operating voltage may comprise about −500 Volts to about 500 Volts. In some examples, the operating voltage may comprise about −200 Volts to about 200 Volts.

In some examples the charge source 410 of discharge element 400 is to generate charges via cycles of alternating current (AC) by which the charge source 410 produces charges having alternating polarity within one full cycle of producing charges. For instance, as shown in FIG. 6A in a first-half of a cycle, a wave of first polarity charges (e.g. positive charges 416B) is emitted and travel toward the grid element 420 with FIG. 6A depicting some such charges 417B after having passed through the holes 423 in the grid element 420 to continue travel toward and engagement of transfer member 430. Meanwhile, as further shown in FIG. 6A, in a second half of the same cycle, a subsequent wave of opposite, second polarity charges 416A (e.g. negative) is emitted and starts migrating toward the grid element 420 and the transfer member 430. A subsequent wave can comprise positive charges 416B, then negative charges 416A, and so on, which results from the alternating current by which the charge source 410 is generating charges.

As this process continues, a field between the grid element 420 and the transfer member 430 continually moves toward the opposite direction (of travel of the charges 416A, 416B) and starts to impede the motion of the negative charges and most of them become attracted to a body of the grid element 420. However, some negative charges 416A may pass through holes 423 in the grid element 420 (instead of being attracted to the body of the grid element 420) and migrate to the transfer member 430 (as represented via charges 417B) and engage the transfer member 430 to negatively charge the transfer member 430. In the next half-cycle when the corona emits positive charges, the positive charges move toward the transfer member 430 with fewer positive charges moving in such fashion as time progresses.

Because most of the charges that would have been collected by the transfer member 430 (if there were no grid element 420) are now collected by the grid element 420, charge dissipation on the transfer member 430 now proceeds at a faster rate than it otherwise would have occurred and proceeds in controllable manner, as described above. In this way, the discharge element 400 including charge source 410 acts to cause discharge of the transfer member 430.

FIG. 6B is a diagram including a side view schematically representing an example discharge element 450 including a charge source 460 which emits charges 466 by direct current 462 at a selected voltage (V3). In some examples, the charge source 460 comprises at least some of substantially the same features and attributes as charge source 410, except for the charge source 460 generating charges 466 at direct current and the charges being a single polarity rather than the alternating polarity as in the example discharge element 400 of FIG. 6A. Stated differently, in the example discharge element 450, the polarity of the charges does not switch between positive and negative charges. In some such examples, a constant voltage (V3) is applied to the charge source 460 (e.g. corona), with one example voltage comprising −5000 Volts. In the illustrated example, as the charge source emits charges 466 (e.g. negative charges in some examples), the charges 466 migrate to the charged surface 468 (e.g. positively charged) of the transfer member 430, with such migration at least initially aided by a field between the grid element 420 and a surface of the transfer member 430. As further charges 466 are emitted by the charge source 460, the field between the grid element 420 and the surface 468 of transfer member 430 continually moves toward the opposite direction and starts to impede the motion of the emitted charges 466 (e.g. negative charges), such that most of the emitted charges 466 migrate to the grid element 420. When enough charges 466 (e.g. negative) have engaged the transfer member 430 to effectively neutralize charges on the transfer member 430, the field between the grid element 420 and the transfer member 430 ensures that no more charges 466 (e.g. negative charges) move towards the transfer member 430 and that they all (or nearly all) of the emitted charges 466 move to the grid element 420. In this way, the discharge element 450 including charge source 460 acts to cause discharge of the transfer member 430.

FIG. 6C is a diagram including a side view schematically representing an example discharge element 470 of an image formation device, with the example discharge element 470 including an energy source 471. The discharge element 470 may comprise at least some of substantially the same features and attributes as, and/or provides an example implementation of, the discharge elements 80, 550, 650, etc. described throughout examples of the present disclosure.

As shown in FIG. 6C, energy source 471 may comprise an ultraviolet (UV) light source 472 or other energy source 473. In some such examples, in which the charge element comprises an UV light source 472, the charge element emits photons 475 to move toward and engage the surface of the transfer member 430. The photons 475 impinge the transfer member 431 to make the transfer member 430 more electrically conductive, which in turn may accelerate decay of charges through the blanket, which may return the transfer member to a generally neutral state at its surface. In some examples, the UV light source may operate at an energy of about 1 to about 20 eV while in some examples, the UV light source may operate at an energy of about 5 to about 10 eV.

FIG. 7A is a diagram including a side view schematically representing at least a portion of an example image formation device 500. In some examples, image formation device 500 comprises at least some of substantially the same features as image formation device 20 or image formation device 150, as previously described in association with FIGS. 1A-6C, except with transfer member 22 arranged in the form of, or as part of, a drum 505 and with the various portions 40, 50, etc. arranged in a circumferential pattern about drum 505 as shown in FIG. 7A. For illustrative simplicity, the various portions 40, 50, etc. of image formation device 500 are represented via boxes instead of dashed lines as in FIGS. 1A, 2A and FIG. 9.

Like the example image formation devices 20, 150 schematically represented in FIGS. 1A, 1D, the example image formation device 500 in FIG. 7A also comprises a discharge element 550 to cause discharge of the transfer member, such as discharge of transfer portion 507 of drum 505. In this way, upon at least some revolutions of drum 505, the discharge element 550 can act to cause discharge of any residual charges built-up (and a corresponding voltage build-up) on the transfer portion 507. In some examples, the discharge element 550 may comprise at least some of substantially the same features and attributes as the discharge elements 80, 400, 450, 470 as previously described in association with at least FIGS. 1A, 1D, 6A-6C. In some examples, the transfer portion 507 may comprise at least some of substantially the same features and attributes as transfer member 22, 280 as previously described in association with at least FIGS. 1A-6C.

As shown in FIG. 7A, first portion 40 comprises the previously identified first receiving portion 510 to removably receive a developer unit, such as developer unit 202 which is removably insertable into the first receiving portion 510 as shown in FIG. 7A. In some examples, the first receiving portion 510 may comprise supports 511. In some examples, the developer unit 202 may comprise at least some of substantially the same features and attributes as developer unit 202 of FIGS. 2A-2B. In a manner similar to that shown in at least FIGS. 1D, 2A-2C for the developer unit 202, the first portion 40 acts to develop and electrostatically deposits an image-receiving holder 24 onto an outer surface 507 of drum 505 to receive droplets of ink, etc.

In some examples, as further described later in association with at least FIG. 10A, among directing other and/or additional operations, a control portion 800 is instruct, or to cause, the developer unit 202 to deliver the image-receiving holder 24 onto transfer member 505, such as within the first portion 40 along the travel path T of transfer member 505 in FIG. 7A.

As shown in FIG. 7A, second portion 50 is downstream from first portion 40 (given a rotational direction P of drum 505) and in some examples may comprises the previously identified second receiving portion 520 to removably receive a fluid ejection device (e.g. 321 in FIG. 3) which is removably insertable into the second receiving portion 520 as shown in FIG. 7B. In some examples, the fluid ejection device 321 may comprise at least some of substantially the same features and attributes as fluid ejection device 321 of FIG. 3. In a manner similar to that shown in at least FIG. 3, when deployed in image formation device 500 in FIGS. 7A-7C the fluid ejection device 321 is to deposit droplets 322 (e.g. 52 in FIG. 1A) of ink particles 34 within a dielectric carrier fluid 32 onto an image-receiving holder 24 supported on the outer surface 507 of drum 505.

In some examples, as further described later in association with at least FIG. 10A, among directing other and/or additional operations, a control portion 800 is instruct, or to cause, the fluid ejection device 321 to deliver the droplets 322 (e.g. 52 in FIG. 1A) onto the image-receiving holder 24 on transfer member 505, such as within the second portion 50 along the travel path T of transfer member 505 in FIG. 7A.

As further shown in FIG. 7A, in some examples the image formation device 500 may comprise a transfer station 540. The transfer station 540 may comprise at least some of substantially the same features and attributes as transfer station 72 of image formation device 20 in FIG. 1A.

In a manner similar to that previously described for image formation device 20, the various portions 40, 50, etc. of image formation device 500 in FIG. 7A may operate as previously described in association with FIGS. 1A-6C to form an image on a print medium 546. As further shown in FIG. 7A, in some examples the image formation device 500 comprises a dryer 530 or comprise another implementation of example energy transfer mechanism 342 in FIG. 5.

FIG. 8 is a diagram including a side view schematically representing at least a portion of an example image formation device 600. In some examples, image formation device 600 comprises at least some of substantially the same features as image formation device 20, 150, 500 as previously described in association with FIGS. 1A-7C, except with transfer member 22 arranged in the form of, or as part of, an endless belt or web 611 and with the various portions 40, 50, etc. of image formation device 600 arranged in a pattern along belt 611 which travels in an endless loop, as shown in FIG. 8. For illustrative simplicity, the various portions 40, 50, 160 etc. of image formation device 600 are represented via boxes instead of dashed lines as in FIG. 1A, 1D.

Like the example image formation devices 20, 150, 500 schematically represented in FIGS. 1A, 1D, and 7A, the example image formation device 600 in FIG. 8 also comprises a discharge element 650 to cause discharge of the transfer member, such as transfer belt 611. In this way, upon at least some revolutions of belt 611, the discharge element 650 can act to cause discharge of any residual charges built-up (and a corresponding voltage build-up) on the transfer belt 611 prior to deposit of a new image-receiving holder onto the transfer belt 611. In some examples, the discharge element 650 may comprise at least some of substantially the same features and attributes as the discharge elements 80, 400, 450, 470 as previously described in association with at least FIGS. 1A, 1D, 6A-6C. In some examples, the transfer belt 611 may comprise at least some of substantially the same features and attributes as transfer member 22, 280 as previously described in association with at least FIGS. 1A-6C.

In some examples, transfer belt 611 forms part of a belt assembly 610 including various rollers 612, 614, 616, 618, 620, etc. and related mechanisms to guide and support travel of belt 611 (e.g. transfer member 22 in FIG. 1A) along travel path T and through the various portions 40, 50, etc. of image formation device 600.

In a manner similar to that previously described for image formation device 20, the various portions 40, 50, etc. operate as previously described in association with FIGS. 1A-7C to form an image on a print medium 546. As further shown in FIG. 8, in some examples the image formation device 600 comprise a transfer station 630 comprising at least some of substantially the same features and attributes as the previously described transfer stations (e.g. 72 in FIG. 1A, 1D; 540 in FIG. 6). In some instances, the roller 620 may serve as, or be referred to, as an impression cylinder. As in the image formation device 500 of FIG. 7A, the image formation device 600 of FIG. 8 also may comprise a dryer 530 or another implementation of example energy transfer mechanism 342 in FIG. 5.

As previously described in association with at least FIGS. 1A-7C, in some examples the first portion 40 may comprise a first receiving portion 510 (FIGS. 6-7) to removably receive a developer unit 202 and/or the second portion 50 may comprise a second receiving portion 520 (FIGS. 6-7A) to removably receive a fluid ejection device 321.

FIG. 9 is a diagram including a side view schematically representing at least a portion of an example image formation device 700. In some examples, the image formation device 700 comprises a transfer member 722 and a series of stations 710, 720, etc. arranged along the travel path T of the transfer member 22 in which each station is to provide one color ink of a plurality of different color inks onto the media. It will be further understood that FIG. 9 also may be viewed as schematically representing at least some aspects of an example method of image formation.

In some examples, the image formation device 700 comprises at least some of substantially the same features and attributes as the image formation devices 20, 150, 500, 600, as previously described in association with FIGS. 1A-8. However, in image formation device 700 a series of image formation stations 710, 720 etc. is provided along a travel path of the transfer member 22. It will be understood that the image formation device 700 can be implemented with the transfer member 22 as a belt (FIG. 8) or as a drum (FIG. 7A) and the various first, second portions, etc. appropriately arranged to such configuration.

In a manner at least substantially the same as in the examples in FIGS. 1A-8, a first portion 40 is located upstream from the series of stations 710, 720 in order to provide an image-receiving holder 24 on a transfer member 22. Following the first portion 40, each subsequent, different image formation station 710, 720, etc. provides for at least partial formation of an image on the image-receiving holder 24 (carried by transfer member 22) by a respectively different color ink. Stated differently, the different stations apply different color inks such that a composite of the differently colored applied inks forms a complete image on the image-receiving holder 24 as desired. In some examples, the different color inks correspond to the different colors of a color separation scheme, such as Cyan (C), Magenta (M), Yellow (Y), and black (K) wherein each different color is applied separately as a layer to the image-receiving holder 24 as image-receiving holder 24 (as supported by transfer member 22) moves along travel path T.

As shown in FIG. 9, each station 710, 720, etc. may comprise at least a second portion 50 and/or third portion 60 having substantially the same features as previously described.

As further shown in FIG. 9, the image formation device 700 may comprise additional stations, and as such, the black circles III, IV represent further stations like stations 710, 720 for applying additional different color inks onto an image-receiving holder 24 (as carried by transfer member 22). In some examples, the additional stations may comprise a fewer number or a greater number of additional stations (e.g. III, IV) than shown in FIG. 9.

In some examples, each station 710, 720, etc. of image formation device 700 can include its own liquid removal element (e.g. 82 in FIG. 1A).

However, in some examples, image formation device 700 comprises just one liquid removal element(s) 82, which is located downstream from multiple color stations 710, 720, etc. such that the cumulative excess liquid (from printing at those stations) is removed all at once. Stated differently, each of the respective color stations 710, 720 omit a liquid removal element (e.g. 82) and liquid removal does not take place until after the last color station in the series of color stations 710, 720, etc.

In some examples, the image formation device 700 may comprise at least one dryer or other implementation of an energy transfer mechanism (e.g. 342 in FIG. 5, 530 in FIG. 7A) downstream from the multiple color stations 710, 720, with the at least one dryer being downstream along the travel path T from the last liquid removal element(s) 82 at the end of the multiple color stations 710, 720, etc.

In some examples, the image formation device 700 also may comprise a transfer station downstream from the multiple stations 710, 720, etc. and which comprises a transfer station comprising at least some of substantially the same features and attributes as transfer station 72 in FIG. 1A, 540 in FIG. 7A, 630 in FIG. 8, etc.

Accordingly, upon the completion of each respective station (e.g. 710, 720), a layer of ink particles 34 will be fixed to the substrate 24, such that later stations will add additional layers of ink particles 34 (of different colors) onto the previous layer(s) of fixed ink particles 34. It will be understood that, for illustrative simplicity, station 720 in FIG. 9 omits depiction of a previously deposited, fixed layer of ink particles from station 710.

As in at least some of the previous examples of the present disclosure, the image formation device 700 may comprise a discharge element like the previously described discharge elements (e.g. 80, 400, 450, 470, 550, 650) to cause discharge of the transfer member 22 with the discharge element located prior to first portion 40 of image formation device 700, after a transfer station, or as otherwise described in the various example discharge elements.

FIG. 10A is a block diagram schematically representing an example control portion 800. In some examples, control portion 800 provides one example implementation of a control portion forming a part of, implementing, and/or generally managing the example image formation devices 20, 150, 500, 600, 700 as well as the particular stations, portions, elements, devices, discharge elements, user interface, instructions, engines, and/or methods, as described throughout examples of the present disclosure in association with FIGS. 1A-9 and 11.

In some examples, control portion 800 includes a controller 802 and a memory 810. In general terms, controller 802 of control portion 800 comprises at least one processor 804 and associated memories. The controller 802 is electrically couplable to, and in communication with, memory 810 to generate control signals to direct operation of at least some the image formation devices, various portions, stations, devices, and/or elements of the image formation devices, such as but not limited to, developer units, fluid ejection devices, charge sources, liquid removal portions, liquid removal, dryers, transfer stations, discharge elements, user interfaces, instructions, engines, functions, and/or methods, as described throughout examples of the present disclosure. In some examples, these generated control signals include, but are not limited to, employing instructions 811 stored in memory 810 to at least direct and manage developing and/or applying an image-receiving holder onto a transfer member, depositing droplets of ink particles and carrier fluid to form an image on a media, directing charges onto ink particles, removing liquids, transferring ink and image-receiving holder onto a print medium, discharging a transfer member, etc. as described throughout the examples of the present disclosure in association with FIGS. 1A-9 and 11. In some instances, the controller 802 or control portion 800 may sometimes be referred to as being programmed to perform the above-identified actions, functions, etc. In some examples, at least some of the stored instructions 811 are implemented as, or may be referred to as, an image formation engine or print engine.

In response to or based upon commands received via a user interface (e.g. user interface 820 in FIG. 10B) and/or via machine readable instructions, controller 802 generates control signals as described above in accordance with at least some of the examples of the present disclosure. In some examples, controller 802 is embodied in a general purpose computing device while in some examples, controller 802 is incorporated into or associated with at least some of the image formation devices, portions, stations, and/or elements along the travel path, developer units, fluid ejection devices, charge sources, liquid removal portions, liquid removal, dryers, transfer stations, discharge elements, user interfaces, instructions, engines, functions, and/or methods, etc. as described throughout examples of the present disclosure.

For purposes of this application, in reference to the controller 802, the term “processor” shall mean a presently developed or future developed processor (or processing resources) that executes machine readable instructions contained in a memory or that includes circuitry to perform computations. In some examples, execution of the machine readable instructions, such as those provided via memory 810 of control portion 800 cause the processor to perform the above-identified actions, such as operating controller 802 to implement the formation of an image as generally described in (or consistent with) at least some examples of the present disclosure. The machine readable instructions may be loaded in a random access memory (RAM) for execution by the processor from their stored location in a read only memory (ROM), a mass storage device, or some other persistent storage (e.g., non-transitory tangible medium or non-volatile tangible medium), as represented by memory 810. The machine readable instructions may include a sequence of instructions, a processor-executable machine learning model, or the like. In some examples, memory 810 comprises a computer readable tangible medium providing non-volatile storage of the machine readable instructions executable by a process of controller 802. In some examples, the computer readable tangible medium may sometimes be referred to as, and/or comprise at least a portion of, a computer program product. In other examples, hard wired circuitry may be used in place of or in combination with machine readable instructions to implement the functions described. For example, controller 802 may be embodied as part of at least one application-specific integrated circuit (ASIC), at least one field-programmable gate array (FPGA), and/or the like. In at least some examples, the controller 802 is not limited to any specific combination of hardware circuitry and machine readable instructions, nor limited to any particular source for the machine readable instructions executed by the controller 802.

In some examples, control portion 800 may be entirely implemented within or by a stand-alone device.

In some examples, the control portion 800 may be partially implemented in one of the image formation devices and partially implemented in a computing resource separate from, and independent of, the image formation devices but in communication with the image formation devices. For instance, in some examples control portion 800 may be implemented via a server accessible via the cloud and/or other network pathways. In some examples, the control portion 800 may be distributed or apportioned among multiple devices or resources such as among a server, an image formation device, and/or a user interface.

In some examples, control portion 800 includes, and/or is in communication with, a user interface 820 as shown in FIG. 10B. In some examples, user interface 820 comprises a user interface or other display that provides for the simultaneous display, activation, and/or operation of at least some of the image formation devices, portions, stations, and/or elements along the travel path, developer units, fluid ejection devices, charge sources, liquid removal portions, liquid removal, dryers, transfer stations, discharge elements, user interfaces, instructions, engines, functions, and/or methods, etc., as described in association with FIGS. 1-10A and 11. In some examples, at least some portions or aspects of the user interface 820 are provided via a graphical user interface (GUI), and may comprise a display 824 and input 822.

FIG. 11 is a flow diagram schematically representing an example method. In some examples, method 900 may be performed via at least some of the same or substantially the same devices, portions, developer units, fluid ejection devices, charge sources, liquid removal portions, transfer stations, discharge elements, control portion, user interface, methods, etc. as previously described in association with FIGS. 1A-10B. In some examples, method 900 may be performed via at least some devices, portions, developer units, fluid ejection devices, charge sources, liquid removal portions, transfer stations, discharge elements, control portion, user interface, methods, etc. other than those previously described in association with FIGS. 1A-10B.

As shown at 902 of FIG. 11, in some examples method 900 comprises applying energy onto an electrically conductive transfer member to discharge the transfer member, while at 904 method 900 may comprise applying a semi-liquid image-receiving holder onto the transfer member. As shown at 906, in some examples method 900 comprises ejecting droplets of ink particles within a carrier fluid onto the image receiving holder on the transfer member to form an image. As shown at 908, in some examples method 900 comprises transferring the ink particles and the image-receiving holder together from the transfer member to an image formation medium.

In some examples, method 900 also comprises performing multiple cycles of image formation in which at least some of the respective cycles may comprise the aspects of method as described at 902, 904, 906, and 908.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. A device comprising:
an at least partially electrically conductive transfer member to travel along a travel path;
a first portion along the travel path to receive an image-receiving holder onto the transfer member;
a second portion downstream from the first portion along the travel path to receive ink particles onto the image-receiving holder to form an image;
a transfer station to transfer the ink particles and the image-receiving holder together from the transfer member to an image formation medium; and
a discharge element, interposed between the transfer station and the first portion, to cause discharge of the transfer member.

2. The device of claim 1, wherein the discharge element comprises a first charge source to emit first charges to cause the discharge of the transfer member.

3. The device of claim 2, wherein the first charge source is to emit the first charges as first polarity charges and opposite second polarity charges in an alternating manner onto the transfer member.

4. The device of claim 2, wherein the first charge source is to emit the first charges as single polarity charges in a direct current mode.

5. The device of claim 1, wherein the discharge element comprises an ultraviolet radiation source to emit ultraviolet radiation onto the transfer member to cause discharge of the transfer member.

6. The device of claim 1, wherein the first portion comprises a developer unit to apply the image-receiving holder as an electrically charged, semi-liquid layer onto the transfer member.

7. The device of claim 1, comprising:
a second charge source to emit second charges to charge the ink particles to move through the carrier fluid to become electrostatically fixed relative to the image-receiving holder

8. The device of claim 1, wherein the second portion comprises a fluid ejection device to eject the ink particles within a carrier fluid as droplets onto the image-receiving holder.

9. The device of claim 1, comprising:
a liquid removal unit downstream from the charge source to remove at least a portion of the carrier fluid from a surface of the image-receiving holder.

10. A discharge element of an image formation device comprising:
an electrically conductive grid element including an array of holes;
a charge source spaced apart from the grid element and to emit charges toward the grid element and toward a transfer member, with the grid element interposed between the charge source and the transfer member;
a control portion to cause the charge source to direct the charges toward the grid element and the transfer member at least until neutralize any residual charges on the transfer member are neutralized,
wherein the discharge element is locatable, along a travel path of the transfer member, prior to a first portion of the image formation device which is to receive an image-receiving holder onto the transfer member.

11. The discharge element of claim 10, wherein the charge source comprises a corona.

12. The discharge element of claim 10, comprising at least one of:
the charge source to emit single polarity charges in a direct current mode; and
the charge source to emit first polarity charges and opposite second polarity charges in an alternating manner onto the transfer member.

13. A method comprising:
applying energy onto an electrically conductive, transfer member to discharge the transfer member;
applying a semi-liquid image-receiving holder onto the transfer member;
ejecting droplets of ink particles within a carrier fluid onto the image receiving holder on the transfer member to form an image; and
transferring the ink particles and the image-receiving holder together from the transfer member to an image formation medium.

14. The method of claim 13, wherein the applying energy comprises at least one of:
directing charges onto the transfer member to neutralize charges on the transfer member; and
directing ultraviolet radiation onto the transfer member to induce decay of charges on the transfer member.

15. The method of claim 14, wherein the directing charges comprises cyclically alternating a polarity of the charges between a first polarity and an opposite second polarity.
